(19) United States
(12) Patent Application Publication
(10) Pub. No.: US 2012/0010996 A1
(43) Pub. Date: Jan. 12, 2012

(54) RECOMMENDATIONS AND TARGETED ADVERTISING BASED UPON DIRECTIONS REQUESTS ACTIVITY AND DATA

(75) Inventors: Eric Horvitz, Kirkland, WA (US); John Charles Krumm, Redmond, WA (US)

(73) Assignee: Microsoft Corporation, Redmond, WA (US)

(21) Appl. No.: 12/831,267

(22) Filed: Jul. 7, 2010

(51) Int. Cl. G01C 21/00; G06Q 30/00; G06F 17/30

(52) U.S. Cl. 705/14.53; 707/771; 701/206; 707/E17.014

(57) ABSTRACT

Concepts and technologies are described herein for providing recommendations and/or advertisements based upon route query activity. A web server is configured to receive queries from an entity. The queries and contextual data associated therewith can be analyzed, and data relating to the queries can be stored by the web server as route activity logs. Adjacent routes and explicit waypoint routing can be abstracted via address directories and ontologies to higher-level goals and the route activities and goals. Such data can serve as case libraries for the construction via machine learning of models that predict interests and preferences with visits to locations and the sequencing of such visits. Training data can include correlated contextual data such as the time and day, prior route queries, and weather, to learn predictive models. Predictions about context- and destination-centric goals and interests can be harnessed to predict preferences, target advertising about waypoints and alternative destinations of potential interest, or advertisements about location-centric or location-independent products or services, all of which can drive recommendations in the present or at a future time.

### BACKGROUND

The use of web-based and/or software-based mapping applications has become a popular aspect of computer usage. For example, many automobiles, smartphones, and/or portable computing devices include mapping applications or programs for generating maps associated with areas or regions, as well as generating driving directions between two or more points. Storage of mapping data in an electronic format allows the maps to be kept updated and accurate, extends the useful life of purchased map products, and provides users with various features that improve the user experience.

While usage of mapping applications or programs has increased, each request received by a map application or program is generally viewed independently as a query for which search results are desired. Furthermore, the identity of one or more entities requesting a certain map or particular map information typically is treated indifferently, as such data typically is not used for any purposes. Thus, each user of the map application, and each request submitted to the map application, may be viewed independently, without regard to other activity of the entity requesting the map information.

It is with respect to these and other considerations that the disclosure made herein is presented.

### SUMMARY

Concepts and technologies are described herein for providing recommendations and advertising based upon route query activity. One or more queries are received by a map application. The queries and contextual information associated with the queries are stored as route activity logs. Other activity associated with an entity, a group of entities, and/or a demographic group within which the entity belongs, may be stored with other data in the route activity logs. For example, contextual information associated with the queries may be stored with or as the route activity logs. The route activity logs can be generated for any number of entities interacting with the map application.

Search queries received by a search engine operating on or in communication with a web server hosting a map application may be analyzed to provide contextual information associated with the route queries. Similarly, when a user submits a query to the web server, the query, contextual information associated with the query, and other queries received from other entities may be stored with or as the route activity logs, to further indicate activity of entities entering particular queries. The route activity logs and/or other stored information relating to queries and search queries can be analyzed to develop statistical and rules-based models that can be used to predict preferences, goals, purposes, and the like of entities who later enter similar or identical queries or search queries.

In particular, received queries and/or search queries can be compared to the route activity logs and/or other stored information to identify similar queries, query or usage patterns, or the like, any or all of which may be determined based upon the developed statistical and/or rules-based models. Based upon the stored information and the received queries and/or search queries, goals, preferences, needs, and/or purposes of entities submitting the queries and/or search queries can be determined, and one or more recommendations and/or advertisements may be generated based upon the predicted goals, preferences, needs, and/or purposes. Thus, the route activity logs and other stored information can be used as case libraries to predict preferences and to suggest sequence visits to waypoints and other points of predicted interest.

According to one aspect, presentation of the recommendations and/or advertisements is effected by the web server by presenting one or more results for the query, as well as one or more recommendations that are believed to be relevant to the query or query results. In some implementations, the recommendations and/or advertisements include one or more adjacent routes, one or more explicit waypoints or types of waypoints, one or more follow-up points, alternative destinations and/or origin points, and the like. In some embodiments, the recommendations may include or may be presented with one or more advertisements that may be selected based upon modeled or predicted interest in the advertisements based upon statistical and/or rules-based models. Thus, relevant data such as waypoints, adjacent routes, advertisements, and the like may be pushed to an entity based upon route queries, search queries, and other activity of the entity and/or other users.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a flow diagram showing aspects of a method for generating and presenting recommendations based upon route query activity, according to an exemplary embodiment.

FIGS. 3A-3B are user interface diagrams showing aspects of exemplary user interfaces for presenting recommendations based upon route query activity, according to various embodiments.

FIG. 4 is a computer architecture diagram illustrating an exemplary computer hardware and software architecture for a computing system capable of implementing aspects of the embodiments presented herein.

### DETAILED DESCRIPTION

The following detailed description is directed to technologies for generating recommendations and advertisements based upon route query, search query, and/or other activity. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for generating recommendations based upon route query activity will be presented.

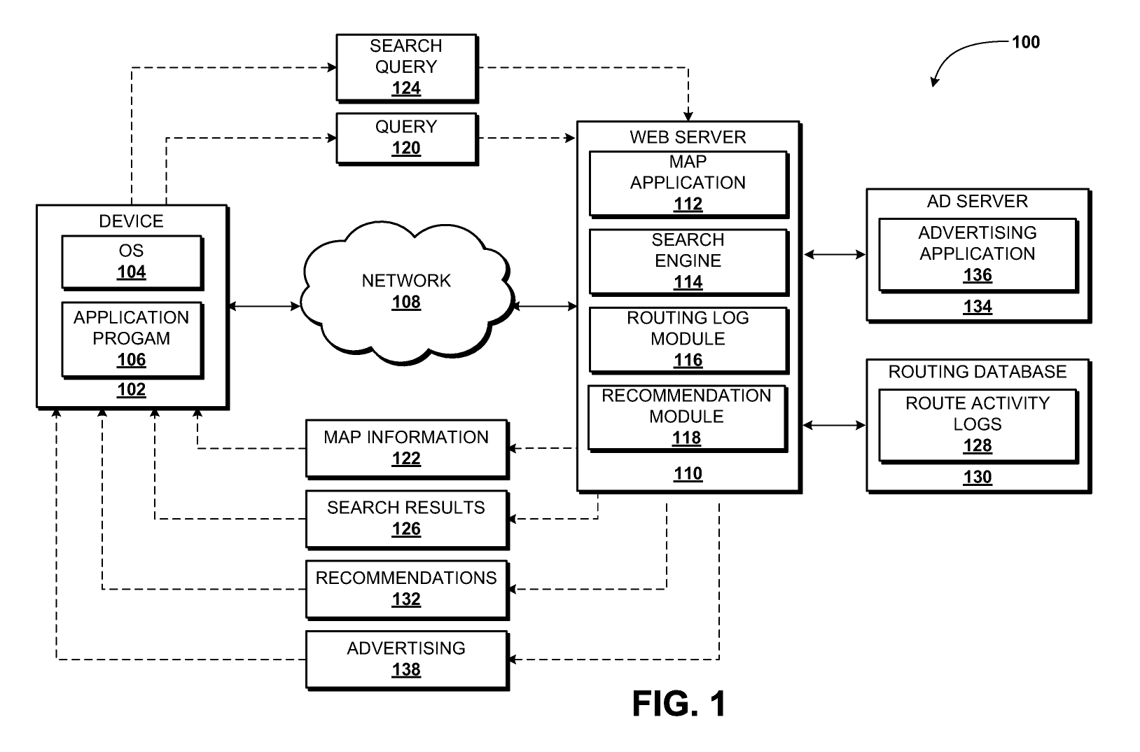

Referring now to FIG. 1, aspects of one operating environment 100 for the various embodiments presented herein will be described. The operating environment 100 shown in FIG. 1 includes a device 102. According to various embodiments, the device 102 is a mobile telephone, a smart phone, a laptop computer, a desktop computer, a server computer, a handheld computer, a netbook computer, or a tablet computer. According to various other embodiments, the device 102 is an embedded computer system, a video game console, a global positioning system (GPS) receiver, a personal digital assistant, and/or another computing device.

The device 102 is configured to execute an operating system 104 and one or more application programs 106. The operating system 104 is a computer program for controlling the operation of the device 102. The application programs 106 are executable programs configured to execute on top of the operating system 104. The application programs 106 will be described herein as a web browser, but it should be understood that the application programs 106 can include almost any kind of program or application including, but not limited to, an email program, a text messaging program, a word processing program, and/or another program or application.

The device 102 may be connected to one or more networks 108. The networks 108 can include any combination of wired and wireless networks including, but not limited to, cellular networks and packet data networks such as the Internet, local area networks (LANs), wide area networks (WANs), and/or other public and/or private networks. The device 102 may operate in conjunction with other computing systems on or in communication with the network 108. In some embodiments, the device 102 communicates with a web server 110 that operates on or in communication with the network 108.

The web server 110 can be accessible via the network 108 and can host one or more applications. In the illustrated embodiment, the web server 110 hosts or is in communication with a map application 112, a search engine 114, a routing log module 116, and a recommendation module 118. Although the map application 112, the search engine 114, the routing log module 116, and the recommendation module 118 are illustrated as components of the web server 110, it should be understood that each of these components, or combinations thereof, may be embodied as or in stand-alone devices or components thereof operating on or in communication with the network 108 and/or the web server 110.

The map application 112 is configured to receive a query 120 and to generate map information 122 in response to the query 120. The query 120 can include a string that is recognized by the map application 112 as a request for map information 122. Generally speaking, the request for map information 122 includes an indication of a particular location, which may be specified broadly or narrowly. In some embodiments, the particular location is specified as longitude/latitude coordinates, a GPS location, a street address, a point of interest, a business, a neighborhood, a ZIP code, a city, a metropolitan area, a state, a country, or the like. Thus, the query 120 may be recognized as a request for map information 122 associated with a particular geographic area or location.

Additionally, the query 120 can be recognized by the map application 112 as a request for directions between two or more points or locations. For example, the query 120 may be recognized as a request for directions between an origin and a destination, either or both of which may be defined in broad or narrow terms as well. The query 120 also may specify one or more waypoints or follow-up points, as will be explained in more detail herein, which may be defined in broad or narrow terms as well. Thus, one or more of the origin, waypoints, the destination, and/or follow-up points may be specified as a large and/or broadly defined area or region, and one or more of the origin, the waypoints, the destination, and/or the follow-up points may be defined as a small and/or narrowly defined area or region.

The map application 112 is configured to access map data, based upon the query 120, and to determine a route between the two or more points. Although not illustrated in FIG. 1, it should be understood that the map application 112 may access one or more databases of location data. In some embodiments, the map application 112 is configured to generate routes that include multiple points. For example, an entity may request directions between an origin and a destination, and the map application 112 can generate the route based upon the origin and destination as specified by the entity. The map application 112 can receive data indicating insertion of a waypoint, a follow-up point, and/or other additional points.

The map application 112 is configured to generate directions from the origin to a waypoint, from the waypoint to another waypoint, if included, and a waypoint to the original destination. Additional directions from the destination to other points such as follow-up points and/or additional waypoints also can be generated. It therefore should be understood that the waypoints and/or follow-up points can be inserted before the origin and/or after the destination, and that the route can be altered accordingly. Furthermore, it should be appreciated that the origin, the waypoints, the destination, and/or the follow-up points can include almost any place of interest including, but not limited to, a zoo, a beach, a restaurant, a store, a museum, a historical site, a city, town, or municipality, and/or another location.

According to various embodiments, the map application 112 is configured to track usage of the map application 112 and to pass usage data to the routing log module 116, as will be explained below. The usage tracked by the map application 112 can relate to any number of entities interacting with the map application 112 and/or the search engine 114. More particularly, routing log module 116 can analyze data collected and/or tracked by the map application 112, the search engine 114, and/or other devices or applications to determine and model behavior of entities entering particular queries 120 or types of queries 120. These models can be used to predict behavior of entities entering similar or identical queries 120, as well as entities having similar or identical traits determined by demographics, search histories, preferences, and the like. It should be understood that the analyzed data can relate to any number of queries 120 submitted by any number of entities

The map application 112 can track data indicating the content of any number of queries 120, as well as contextual data indicating various aspects associated with the queries 120. The map application 112 also can track other activity of entities submitting the queries 120 such as, for example, searches or other activity occurring between the entities and the search engine 114 before and/or after the queries 120 are received at the map application 112. In some embodiments, for example, the map application 120 tracks locations associated with the queries 120, times of day at which the queries 120 are received, other activity of the entities associated with the queries 120, other information, combinations thereof, and the like, as will be described in more detail below. The tracking feature can be disabled, if desired, by the entity if the entity does not wish to use the functionality of the web server 110 described herein, or to address perceived security and/or privacy concerns.

The search engine 114 is configured to receive a search query 124, to perform a search in response to the search query 124, and to generate search results 126 in response to the search query 124. The search query 124 can include a search string submitted by the entity, and can include a request for data of almost any kind including, but not limited to, news, images, video, audio, text, and/or other content or information. As mentioned above, activity at the search engine 114 can be tracked by the map application 112 and/or other tracking modules (not illustrated) associated with the web server 110, and can be used to generate the statistical and/or rules-based models described herein.

In some embodiments, the search engine 114 tracks usage data for use by the recommendation module 118, and is configured to pass the usage data to the routing log module 116 for storage, analysis, and/or other operations. The search engine 114 is configured to track data indicating the content of the search query 124 as well as contextual data indicating various aspects associated with the search query 124. In some embodiments, for example, the search engine 114 tracks a location associated with the search query 124, an entity associated with the search query 124, if known, a time of day at which the search query 124 was received, session data, query history, and routing activity such as, but not limited to, submitted queries 120, origin and/or destination information, added or removed waypoints, added or removed follow-up points, other information, combinations thereof, and the like. As mentioned above with respect to the map application 112, the tracking feature of the search engine 114 can be disabled, if desired.

The routing log module 116 is configured to receive usage data from the map application 112 and the search engine 114. The usage data includes data indicating the content of the queries 120 and the search queries 124, as well as contextual data associated with the queries 120 and the search queries 124. The routing log module 116 is configured to analyze the received data, to correlate the received data to generate route activity logs 128, and to store the route activity logs 128 in a data storage location. It should be understood that the route activity logs 128 can include data relating to any number of entities communicating with the map application 112 and/or the search engine 114. The data storage location can include a memory, a server, a database, or other suitable storage location. In the illustrated embodiment, the data storage location is a routing database 130.

The routing log module 116 also is configured to analyze the received data to identify patterns, probabilities, goals, intentions, topics, and the like, associated with the received data and/or entities associated with the received data. The patterns, probabilities, goals, intentions, topics, and the like can be determined and/or associated with one or more entities, categories of entities, and/or types of entities submitting the queries 120 and/or the search queries 124. Additionally, the patterns, probabilities, goals, intentions, topics, and the like, can be determined and/or associated with one or more locations relating to routes associated with the queries 120 such as origins, destinations, waypoints, and/or follow-up points, as well as categories or types of locations, which can be based upon geographic region, weather, demographics, state, county, and/or other aspects of the locations. In some embodiments, directory services are used to map locations with topics, categories or types of locations, and/or other information associated with the locations.

Thus, the route activity logs 128 can be analyzed to determine a set or hierarchy of topics or goals associated with particular locations or routes between locations. As such, preferences, purposes, goals, or intents associated with entities submitting other queries 120 can be predicted based upon modeled behavior. Similarly, contextual variables associated with routing activity can be analyzed to provide additional information regarding queries 120 and/or entities associated with the queries 120. Exemplary contextual variables include, but are not limited to, a time of day, week, month, and/or year associated with the queries 120, geographic regions associated with the queries 120, demographics of origins, waypoints, follow-up points, and/or destinations associated with the queries 120, and the like. All of these data can be analyzed and/or machine learned to identify patterns and probabilities associated with various routing and searching activities, and to construct statistical and rules-based models. The patterns and/or probabilities can be used to assume or project activities or traits associated or expected to be associated with other entities submitting or associated with similar or related queries 120, based upon the patterns, probabilities, goals, and the like.

It should be understood that the above patterns, probabilities, goals, and the like can be determined and/or applied to other activity such as search queries 124, queries 120, or other activity based upon any number of models. Exemplary modules include, but are not limited to, Bayesian network models, Hidden Markov Models (“HMMs”), other statistical models, and/or other models. Such models can be used to predict or project related search queries 124 and/or queries 120 of entities based upon the contents of the route activity logs 128. For example, a query 120 relating to directions between an origin and a destination may be received. The entity submitting the query 120 may add a waypoint and/or a follow-up point. This activity can be represented by data stored as the route activity logs 128, effectively being stored as a case history or case in a library of cases.

If another query 120 relating to directions between the origin and the destination is received, the likelihood that the entity submitting the query 120 will request the waypoint and/or the follow-up point, or a similar waypoint or follow-up point, can be assigned respective probabilities based upon the previously captured activity, as reflected by the route activity logs 128. These waypoints and/or follow-up points can be suggested to the entity, if desired, as is described in more detail herein. It should be understood that adjacent route paths also can be built, depending upon predicted preferences and interests.

The route activity logs 128 include data that represents activity of any number of entities interacting with the map application 112 and/or the search engine 114. The contextual data collected with the content of the queries 120 and the search queries 124 is used to recognize how entities search for map information 122, as well as search results 126. For example, an entity may submit queries 120 and search queries 124 relating to a planned vacation to New York City, N.Y. The route activity logs 128 can include data representing interactions of the entity with the map application 112 and/or the search engine 114.

In an illustrative example, the entity may submit a query 120 for driving directions from his or her home to New York City. The route activity logs 128 may include an indication of this query 120, and may store contextual information related to this activity such as the location at which the query 120 was generated or location information identifying the origin used to generate the driving directions, either or both of which may be associated with the location of the entity. The entity also may search a New York City map for hotels, restaurants, museums, and other places of interest. Some, none, or all of these queries 120 and/or search queries 124 can be tracked by the map application 112 and/or the search engine 114, stored in a route activity log 128, and/or associated with an abstracted or generic user from the location associated with the queries 120 or the search queries 124.

It should be understood that the route activity logs 128 can be generated not only for individual entities, but also for classes or categories of entities, entities associated with a particular location, entities specifying a particular origin or start point, and the like. Therefore, when an entity submits the query 120, the route activity logs 128 can be used to create a generalization or abstraction of the entity such that activity associated with other entities with similar demographics, locations, or search patterns can be mined to identify and generate recommendations 132. The route activity logs 128 can be used by the recommendation module 118, as will be explained below, to push recommendations to entities whose activity is similar in some respect to activity of another entity, category of entity, abstracted entity, location of an entity, or the like.

The recommendations 132 can include, but are not limited to, suggested waypoints, suggested follow-up points, alternative origin and/or destination points, alternative route paths, advertising information, and the like. The recommendations 132 can be presented to a user with options to insert the recommendations into a route, and/or information indicating how insertion of the recommendations 132 into the route will affect the route in terms of distance, time, cost, tolls, traffic, and the like. In some embodiments, the recommendations 132 are generated during a first session, and the recommendations are based upon activity of the entity during the first session. The recommendations can be presented during the first session and/or during a second or subsequent session that includes activity similar to the first session.

The recommendation module 118 is configured to analyze usage of the web server 110 by an entity, as well as the route activity logs 128. The recommendation module 118 analyzes a received query 120 or search query 124, as well as contextual data associated therewith. As mentioned above, the contextual data can indicate a location associated with the entity or the query 120, which may be the point of origin of a driving directions request or other query 120. The contextual data also can include a time of day at which the query 120 is received, as well as demographics data corresponding to the location associated with the entity or the query 120. It should be understood that demographics information or other data associated with the locations may be retrieved from one or more databases, servers, or other devices accessible to the recommendation module 118 (not illustrated in FIG. 1).

Additionally, the route activity logs 128 can be used to determine if the entity, or a similar entity or category of entities, has submitted a query 120 to the map application 112 before, and/or a search query history associated with the entity(ies), which may indicate searches submitted before or after the query 120 was created. The recommendation module 118 can analyze all the data to generate one or more recommendations 132 for the entity based upon prior activity of the entity and/or related entities, prior activity of other entities that are similar to the entity, demographics information associated with the query 120 or a search query 124, combinations thereof, and the like.

In some embodiments, the operating environment 100 includes an advertising server 134 (“ad server”). The ad server 134 hosts an advertising application 136 for generating advertising 138. In some embodiments, the advertising 138 relates to one or more of the recommendations 132 generated by the recommendation module 118. Thus, the advertising 138 can include a coupon, sales code, or other information relevant to a waypoint, follow-up point, or other recommendation 132, as will be explained in more detail below. In some embodiments, the advertising 138 relates to activity of an entity, and is generated based upon information in the route activity logs 128.

The advertising application 136 is configured to communicate with the web server 110 to receive data from the web server 110 and/or components thereof such as the recommendation module 118. For example, the recommendation module 118 can transmit data to the ad server 134 indicating that a recommendation is to be made to an entity, and indicating the subject matter of the recommendation 132. The ad server 134 can be configured to analyze the data received from the recommendation module 118, identify advertising 138 associated with the recommendation 132, and pass the advertising 138 to the web server 110. The advertising 138 can be transmitted to the device 102 with the map information 122, the search results 126, and/or the recommendations 132. As mentioned above with respect to the recommendations 132, the advertising 138 can be presented during a first, second, and/or subsequent session, and is not necessarily presented at the time the advertising 138 is generated.

In some embodiments, an operator associate with the web server 110 sells advertising based upon patterns and/or probabilities, as mentioned above. For example, a particular query 120 for directions between an origin and a destination often may be followed or accompanied with a request for directions to a particular waypoint, or a particular type of waypoint. Thus, advertising based upon the expected waypoints or types of waypoints can be sold based upon a probability recognized in view of receiving a particular query 120, for example, or based upon contextual information associated with one or more queries 120 or entities associated with the queries 120, if desired. In one embodiment, a first price is charged for advertising 138 associated with waypoints that are expected with a first probability, and a second, higher price, is charged for advertising 138 associated with waypoints that are expected with a second, higher probability. These examples are illustrative, and should not be construed as being limiting in any way.

In one exemplary embodiment, the route activity logs 128 store logs of activity associated with entities or types of entities who have requested directions between a first point and a second point. During these requests, entities requested, on average with a probability of P, directions to a waypoint. The operator can sell advertising space to businesses categorized as the identified type of waypoint who want to push information relating to their business to the entities. Businesses may be enticed to purchase such advertising based upon an understanding that entities requesting the information to which the waypoints relate are expected to be interested in their goods and/or services. In other words, the businesses may appreciate that these entities are going to receive highly targeted advertising, with an associated high rate of returns.

The advertising 138 can be passed as graphics, text, or banners, or can be passed as the recommendations 132. For example, information for a waypoint can be displayed with options to add the waypoint to a route. The information for the waypoint can include a total increase or decrease in the mileage associated with a requested route, a time increase or reduction associated with adding or removing the waypoint to/from the route, links to reviews associated with the waypoint, advertising or special offers associated with the waypoints, and the like. The advertising 138 and/or the recommendations 132 can be subject to various thresholds as determined by operators, preferences, settings, and the like. For example, in some embodiments, the advertising 138 and/or the recommendations 138 are presented only if a location associated with the recommendation 132 is within a threshold distance from a location associated with the query 120, e.g., an origin, destination, waypoint, route path, and/or follow-up point. In one embodiment, the distance threshold is 0.25 miles and the time threshold is five minutes roundtrip. This embodiment is exemplary, and other thresholds are contemplated and are possible.

For the sake of clarity, FIG. 1 illustrates one device 102, one network 108, one web server 110, one routing database 130, and one ad server 134. It should be understood, however, that some implementations of the operating environment 100 include multiple devices 102, multiple networks 108, multiple web servers 110, multiple routing databases 130, and/or multiple ad servers 134. Therefore, the illustrated embodiment should be understood as being exemplary, and should not be construed as being limiting in any way.

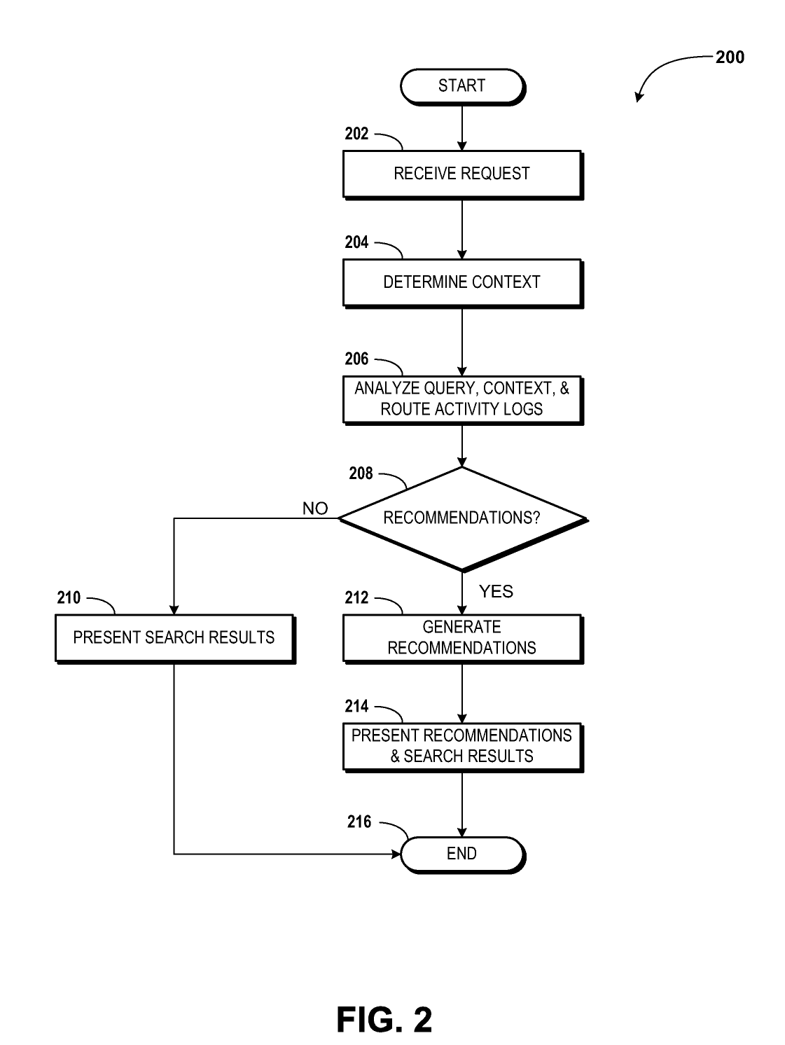

Turning now to FIG. 2, a method 200 for generating and presenting recommendations based upon route query activity will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined above. The term “computer-readable instructions,” and variants thereof, as used in the description and claims, is used expansively hereinto include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the web server 110. It should be understood that this embodiment is exemplary, and should not be viewed as being limiting in any way. The method 200 begins at operation 202, wherein the web server 110 receives a request. The request can include the query 120 and/or the query 124, as described above.

From operation 202, the method 200 proceeds to operation 204, wherein the web server 110 analyzes the context in which the request was received. As explained above, the context of the query 120 and/or the search query 124 can include various data associated therewith. For example, the context can include, but is not limited to, the time of day at which the query 120 or search query 124 was received, a location associated with the query 120 or the search query 124, and other activity of an entity from who the query 120 or the search query 124 was received. These examples of context are exemplary, and it should be understood that context data associated with other activity of the entity may be captured by the web server 110 and/or a component thereof.

As mentioned above, the location associated with the query 120 or the search query 124 can include a location from which the query 120 or the search query 124 was submitted and/or location information included in the query 120 or the search query 124. The location associated with the query 120 further may include an origin, a destination, and/or one or more waypoints included in the query 120.

The context of the query 120 or the search query 124 further can include information relating to other queries 120 or search queries 124 associated with the entity. For example, search queries 124 received by the web server 110 before or after the query 120 was received can be analyzed to learn more about the entity associated with the query 120. Thus, the query 120 or the search query 124 may be viewed not only independently, but also in the context of some or all activity of the entity. Thus, the content and context of the query 120 and/or the search query 124 may be viewed in the context of all of the entity's activity with the map application 112 and/or the search engine 114. For example, if an entity submits several search queries 124 concerning “vacation AND hotel AND manhattan AND four star,” and then submits a query 120 for hotels in Manhattan, the web server 110 may view the query 120 in the context of the entity's session with the web server 110, and retrieve four star or similar hotels in Manhattan, instead of merely retrieving all hotels. Additionally, or alternatively, the web server 110 can recommend four star hotels in Manhattan in response to the query 120, but also include all hotels in Manhattan as literally satisfying the query 120. This example is merely illustrative of the principles and concepts disclosed herein, and should not be construed as being limiting in any way.

In one embodiment, the recommendation module 118 is configured to learn and/or recognize co-occurrences of queries 120 and/or search queries 124 based upon analyzing interactions with the web server 110 over time. For purposes of this application, the term “co-occurrence” is used to indicate a recognized correlation between a first search and a second search. Data corresponding to the co-occurrences may be stored as the route activity logs 128, and can be used to find recommendations based upon received queries 120 and/or search queries 124. For example, the recommendation module 118 can recognize that a query 120 for “hotels and motels” in a particular location is often followed by a search for “restaurants” in the location. Similarly, the recommendation module 118 can recognize that a search for a doctor's office is often followed by a search for pharmacies, drug stores, and/or medical supply stores. Therefore, if the query 120 or the search query 124 includes a string or topic that has a recognized co-occurrence, the recognized co-occurrence can be presented to the entity as a recommendation 138.

It also should be understood that co-occurrences can be determined from the route activity logs 128 based upon, for example, queries 120 for routes that include one or more waypoints. For example, the route activity logs 128 may indicate that entities who request directions to doctor sometimes request directions to a pharmacy. Such an indication is another example of a co-occurrence. It should be understood that these co-occurrences can be assigned or associated with one or more probabilities and/or confidence intervals. It further should be understood that these examples are illustrative.

According to various embodiments, the web server 110 is configured to recognize goals, tasks, preferences, and the like, that may be abstracted from particular locations. The web server 110 can machine learn rules-based and/or statistical models for predicting behavior, goals, tasks, preferences, needs, and the like, associated with entities submitting These goals, tasks, preferences, and the like, can be based upon the actual location, consideration of nearby locations, co-occurrences in historical requests for similar or identical routes, and/or similar information. Some, none, or all of these goals, tasks, preferences, and the like, can be used to generate recommendations 132, as explained herein.

In addition to recognizing co-occurrences of explicit locations such as waypoints, and the like, the web server 110 also can be configured to recognize co-occurrences based upon type, category, and/or other broad definition of waypoints, follow-up points, origins, destinations, and the like. For example, if a query 120 includes directions to a Chinese-style restaurant, the web server 110 can generate recommendations 132 relating to other Chinese restaurants, other Asian restaurants, or other restaurants, depending upon how narrowly defined the recommendations 132 are intended to be. These examples are illustrative, and should not be construed as being limiting in any way.

From operation 204, the method 200 proceeds to operation 206, wherein the web server 110 analyzes the query 120 or the search query 124, the contextual information, and the route activity logs 128 to determine if any recommendations should be made to the entity. The web server 110 can search the route activity logs 128 for activity that is similar to the activity associated with the entity, as explained above with reference to FIG. 1. Additionally, the web server 110 can apply the machine-learned rules-based or statistical models to predict behavior of the entity based upon the query 120 or the search query 124, as well the route activity logs 128. For example, the web server 110 can look for any entity that entered a query 120 or a search query 124 that is similar to the query 120 or the search query 124. Similarly, the web server 110 can search the route activity logs 128 based upon one or more locations associated with the entity generating the query 120 and/or the search query 124, which can be based upon demographics, a type or category of location, an actual location, a street address, combinations thereof, and the like. Additionally, the web server 110 can apply one or more models to the query 120 or the search query 124 to predict or model the entity and/or preferences, goals, intents, purposes, and the like associated with the route and/or interactions with the entity. Other contextual and explicit data can be analyzed, as explained above.

Identifying entities that have similar activity or patterns of activity, for example, who have entered similar queries 120 or search queries 124, may be understood by the web server 110 as an indication that the two entities are similar. Therefore, the web server 110 can determine that the entity associated with the query 120 and/or the search query 124 has similar tastes, interests, needs, patterns, demographics, and/or usage patterns as the entity associated with route activity logs 132. Similarly, the web server 110 can analyze activity occurring before the web server 110 receives the query 120 or the search query 124, and determine if that activity is similar to any activity associated with the entity. These and other similarities or expected similarities can be determined and/or expected with one or more probabilities, as mentioned above.

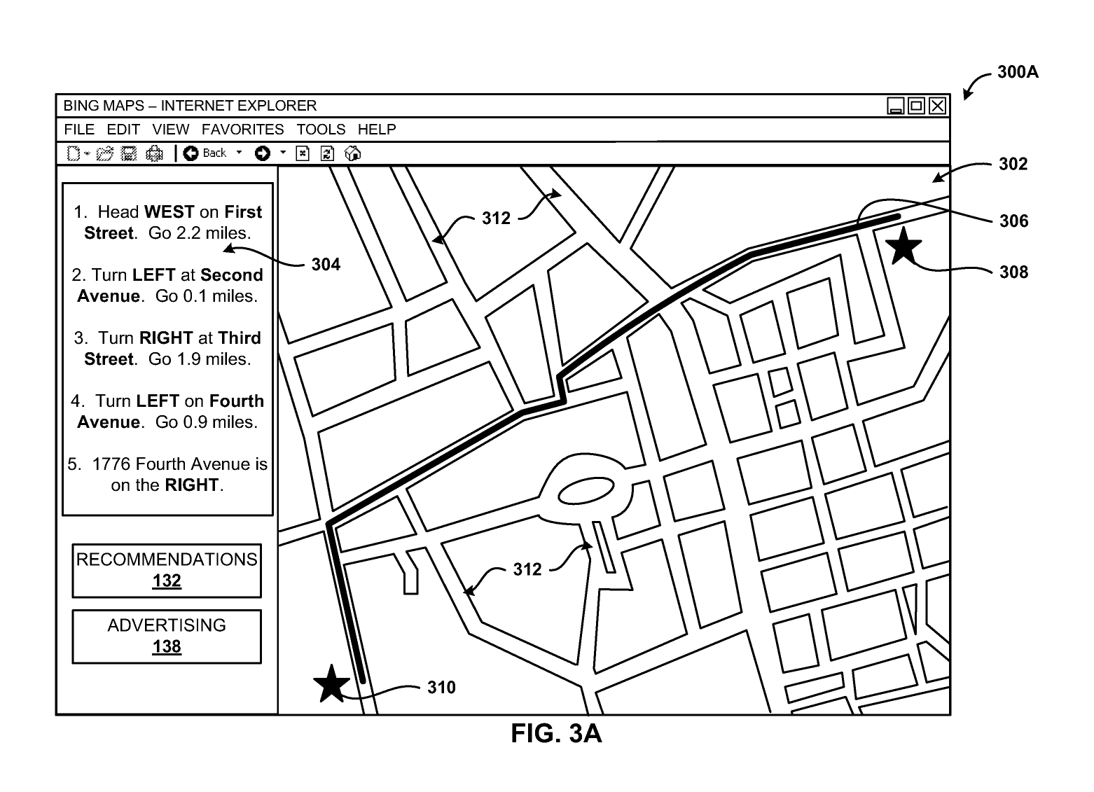

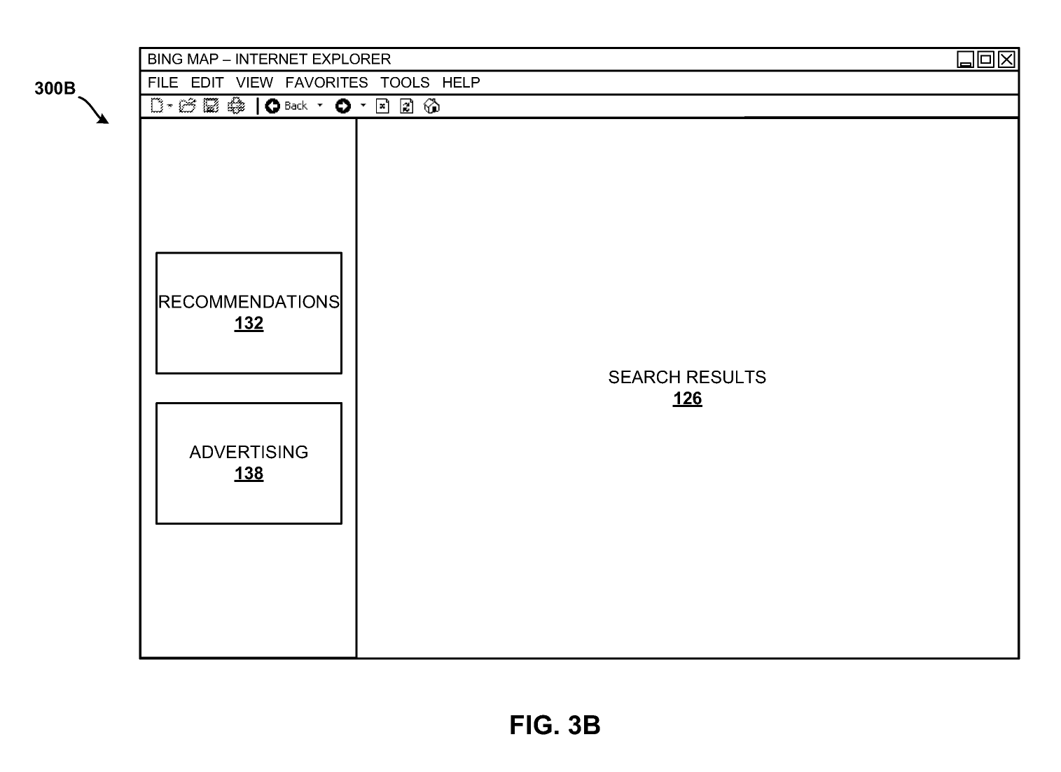

From operation 206, the method 200 proceeds to operation 208, wherein the web server 110 determines if there are any recommendations 132 for the entity. If the web server 110 determines that there are no recommendations 132 for the entity, the method 200 can proceed to operation 210, wherein the search results are presented to the device 102. After presenting the search results to the device 102, the method 200 ends. Exemplary embodiments of presentation of recommendations 132 are illustrated below in FIGS. 3A-3B. Returning briefly to operation 208, if the web server 110 determines that recommendations 132 should be made to the entity, the method 200 can proceed to operation 212.

At operation 212, the web server 110 generates recommendations 132 for the entity. The recommendations 132 can be a form of suggested waypoints, adjacent or alternative route paths, suggested waypoint substitutions, suggested destination substitutions, suggested follow-up point additions or substitutions, text indicating a suggested place of interest or a local attraction, coupons and/or special offers presented to an entity for use at a suggested place of interest or attraction, other recommended activities or information, combinations thereof, and the like. Furthermore, operation 212 includes formatting the recommendations 132 for use by the party receiving the recommendations 132.

According to various implementations, the recommendations 132 generated or presented can include recommended locations and/or advertising 138 associated with recommended locations. The recommendations 132 and/or the advertising 138 can be associated with and/or can prompt various actions. For example, a recommendation 132 and/or advertising 138 could prompt an option to replan a route associated with the query 120. In an illustrative example, an entity may submit a query 120 requesting directions to the symphony. Based upon the route activity logs 128 and/or other information, the web server 110 may generate a recommendation 132 for a high-end restaurant near the symphony. For example, other users requesting directions to the symphony may enter the restaurant as a waypoint. Presentation of the recommendation 132 may include an option to enter the restaurant as a waypoint, and to recalculate the route including the restaurant as a waypoint or follow-up point entered in the route before the origin, between the origin and the destination, and/or after the destination.

From operation 212, the method 200 proceeds to operation 214, wherein the web server 110 presents the recommendations 100 and the search results 126. According to some embodiments, presenting the recommendations 132 includes inserting a recommendation 132 into a search results page and/or prompting the requesting entity for input indicating if a recommendation 132 should be inserted into a search results page, a map, a route, or the like. A search results page can be presented on a display, and a recommendation 132 can be embedded in the image shown on the display, for example as a coupon, an advertisement or as other data. Exemplary user interfaces for providing the recommendation 132 and/or the search results will be presented below with reference to FIGS. 3A-3B.

In some embodiments, a recommendation 132 includes a suggested waypoint, origin or destination change, follow-up point insertion, and/or the like for a route. According to various embodiments, the recommendation 132 is made with information indicating how the recommendation will alter the route, which can include an increase or decrease in distance or time, or the like. All of the examples disclosed above are illustrative, and should not be construed as being limiting in any way. The method 200 ends at operation 216.

Turning now to FIG. 3A, a user interface diagram showing aspects of a user interface (UI) for presenting recommendations based upon route query activity in one embodiment will be described. In particular, FIG. 3A shows a screen display 300A generated by one or more of the application programs 106 according to one particular implementation presented herein. In this implementation, the application programs 106 include a web browser for interacting with the web server 110. It should be appreciated that the UI diagrams illustrated in FIGS. 3A-3B are exemplary.

The screen display 300A shown in FIG. 3A includes various tool bar and menu items. It should be understood that the illustrated tool bar and menu items are merely illustrative, and that additional and/or alternative tool bar and/or menu items are possible and are contemplated. In the illustrated embodiment, the screen display 300A includes a map 302 and directions 304. The map 302 and the directions 304 can be visual representations of the map information 122 described above with reference to FIG. 1. The map 302 includes a visual representation of a route 306 between an origin 308 and a destination 310, while the directions 304 include turn-by-turn instructions for the entity to navigate the route 306. While the illustrated map 302 includes a route 306 that makers use of a number of roads 312, it should be appreciated that the concepts and technologies described herein may be employed with maps that include hiking trails, bike paths, sidewalks, rail lines, public transit maps, and other modes of transportation instead of, or in addition to, streets or roads intended for automobile traffic.

As explained above, a query 120 is received by the web server 110, and may be recognized by the web server 110 or a component thereof as a request for driving directions, a map of a designated area, or another request for map information 122. The web server 110 can be configured to pass the query 120 to the map application 112, and the map application 112 generates the map 302 in response to the query 120. In addition to generating the map 302, the map application 112 can generate the directions 304. Additionally, as explained above, the web server 110 is configured to pass the query 120 to the recommendation module 118 for determining if the web server 110 should generate a recommendation 132 based upon the query 120.

In the context of FIG. 3A, the recommendation module 118 can access the route activity logs 128 to identify route activity logs 128 associated with the entity submitting the query 120, the origin 308, the destination 310, or the geographic location or area associated with the map 302. Any relevant route activity logs 128 can be analyzed by the recommendation module 118 to identify recommendations 132.

The recommendations 132 can be identified by matching activity of the route activity logs 128 with activity of the entity submitting the query 120. The recommendations 132 also can be identified based upon other analysis of the entity, the context in which the entity submitted the query 120. For example, if a user whose activity is reflected in the route activity logs 128 submitted a query 120 for directions to or from the origin or destination specified in the query 120, a correlation can be drawn between the entity's activity and the activity of the user. If the user requested additional map information 122 associated with other points near the origin or destination, those points may be presented to the entity as recommendations 132, as the web server 110 can assume that the entity and the user share similar interests, at least with respect to the subject matter of the query 120. In the context of the map 302, a recommendation 132 can include a suggested waypoint entry/insertion.

To illustrate the scenario described above, the following example assumes that the address of the destination 310 is the street address of a museum. The route activity logs 128 may include many entries indicating requests that include the address of the museum, some, all, or none of which may be associated with searching entities. Additionally, the route activity logs 128 can include data indicating other activity of the searching entities. When another user or entity enters a search that is similar to a search submitted by the user, the web server 110 can create a recommendation relating to the museum, as the activity of other users suggests that the entity may be interested in the museum as well.

As shown in FIG. 3A, the screen display 300A also can include an advertisement 138. The advertisement can relate to the recommendation 132, and can include, for example, a coupon code, a bar code, a sales event, or other information. It should be understood that the advertisement 138 and the recommendation 132 may be combined. For example, a coupon for a good or service may be generated with a caption suggesting that the entity consider the good or service indicated by the caption. This example is merely illustrative, and should not be construed as being limiting in any way.

Turning now to FIG. 3B, a user interface diagram showing aspects of a user interface (UI) for presenting recommendations based upon route query activity in another embodiment will be described. In particular, FIG. 3B shows a screen display 300B generated by one or more of the application programs 106 according to another implementation. In this implementation, the application programs 106 include a web browser for interacting with the search engine 114.

The screen display 300B shown in FIG. 3B includes a visual representation of the search results 126. The search results 126 may include a results page generated by the search engine 114 in response to the search query 124, as is generally known, though other embodiments are contemplated. It should be understood that the search results 126 can include images, text, links, audio, video, and/or other content. The screen display 300B also may include one or more recommendations 132 and one or more advertisements 138.

As explained above, a search query 124 may be received by the web server 110, and may be recognized by the web server 110 or a component thereof as being submitted by or associated with an entity that has interacted with the map application 112. The web server 110 can be configured to pass the search query 124 to the recommendation module 118 for determining if the web server 110 should generate a recommendation based upon the search query 124. As explained above, the recommendation module 118 can analyze activity of the entity, and not merely the search query 124, to determine if the entity has submitted one or more queries 120, and if so, how the search query 124 relates to the one or more queries or other activity of the entity. Thus, the recommendation module 118 can analyze one or more route activity logs 128 to determine if one or more recommendations 132 should be provided to the entity.

The recommendations 132 can be generated based on all activity of the entity with the map application 112 and/or the search engine 114, and not merely the plain language of a query 120 or search query 124. Thus, relevant information, in the form of one or more recommendations 132 and/or advertisements 138 may be pushed to the entity based upon various interactions with the web server 110.

In some embodiments, the web server 110 includes functionality of a search engine 114. For example, the functionality of the search engine 114 can be provided by a server or other device providing a search service such as, for example, the BING search service from MICROSOFT CORPORATION of Redmond, Wash. Advertising space may be sold based upon the type of entity at which advertisements will be targeted. By way of example, a particular demographic may be associated with a route activity log 128. The web server 110 may be configured to push advertisements 138 associated with expensive hotels to entities matching characteristics of the particular demographic. The cost of the advertisements 138 focused at the particular demographic may be adjusted based upon anticipated returns on the advertisements 138. Thus, if the particular demographic includes a wealthy entrepreneurial class of users, advertisements 138 for laptop computers or smart phones may be more expensive than similar advertisements directed to demographics with less disposable income and/or need for laptop computers or smart phones. The above examples are illustrative, and should not be construed as being limiting in any way.

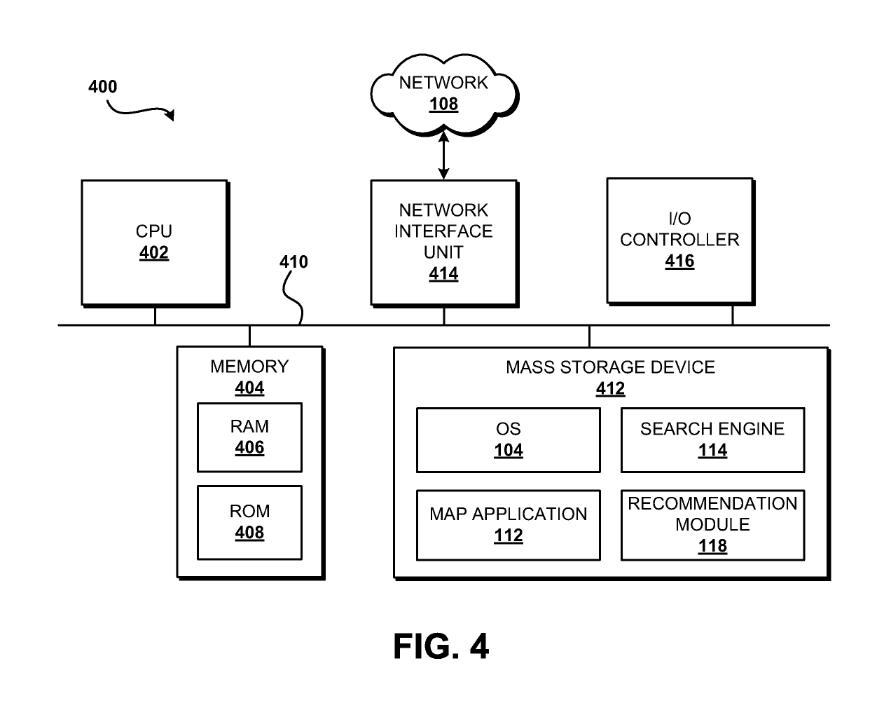

FIG. 4 illustrates an exemplary computer architecture 400 for a device capable of executing the software components described herein for generating recommendations based upon routing activity as described above. Thus, the computer architecture 400 illustrated in FIG. 4 illustrates an architecture for a server computer, mobile phone, a PDA, a smart phone, a server computer, a desktop computer, a netbook computer, a tablet computer, and/or a laptop computer. The computer architecture 400 may be utilized to execute any aspects of the software components presented herein, including the operating system 104, the application programs 106, the map application 112, the search engine 114, the routing log module 116, the recommendation module 118, the advertising application 136, and/or other software.

The computer architecture 400 illustrated in FIG. 4 includes a central processing unit 402 (“CPU”), a system memory 404, including a random access memory 406 (“RAM”) and a read-only memory (“ROM”) 408, and a system bus 410 that couples the memory 404 to the CPU 402. A basic input/output system containing the basic routines that help to transfer information between elements within the computer architecture 400, such as during startup, is stored in the ROM 408. The computer architecture 400 further includes a mass storage device 412 for storing the operating system 104, the map application 112, the search engine 114, the routing log module 116, and the recommendation module 118. Although not illustrated in FIG. 4, it should be understood that the mass storage device 412 can store the application programs 106, the routing log module 116, and/or the advertising application 136. The mass storage device 412 also can be configured to store data such as the data stored by the routing database 130.

The mass storage device 412 is connected to the CPU 402 through a mass storage controller (not shown) connected to the bus 410. The mass storage device 412 and its associated computer-readable media provide non-volatile storage for the computer architecture 400. Although the description of computer-readable media contained herein refers to a mass storage device, such as a hard disk or CD-ROM drive, it should be appreciated by those skilled in the art that computer-readable media can be any available computer storage media that can be accessed by the computer architecture 400.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 400.

According to various embodiments, the computer architecture 400 may operate in a networked environment using logical connections to remote computers through a network such as the network 108. The computer architecture 400 may connect to the network 108 through a network interface unit 414 connected to the bus 410. It should be appreciated that the network interface unit 414 also may be utilized to connect to other types of networks and remote computer systems, for example, the device 102, the web server 110, the routing database 130, and/or the ad server 134. The computer architecture 400 also may include an input/output controller 416 for receiving and processing input from a number of other devices, including a keyboard, mouse, or electronic stylus (not shown in FIG. 4). Similarly, the input/output controller 416 may provide output to a display screen, a printer, or other type of output device (also not shown in FIG. 4).

As mentioned briefly above, a number of program modules and data files may be stored in the mass storage device 412 and RAM 406 of the computer architecture 400, including an operating system 104 suitable for controlling the operation of the server, desktop, and/or laptop computer. The mass storage device 412 and RAM 406 also may store other types of program modules and data.

It should be appreciated that the software components described herein may, when loaded into the CPU 402 and executed, transform the CPU 402 and the overall computer architecture 400 from a general-purpose computing system into a special-purpose computing system customized to facilitate the functionality presented herein. The CPU 402 may be constructed from any number of transistors or other discrete circuit elements, which may individually or collectively assume any number of states. More specifically, the CPU 402 may operate as a finite-state machine, in response to executable instructions contained within the software modules disclosed herein. These computer-executable instructions may transform the CPU 402 by specifying how the CPU 402 transitions between states, thereby transforming the transistors or other discrete hardware elements constituting the CPU 402.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 400 in order to store and execute the software components presented herein. It also should be appreciated that the computer architecture 400 may include other types of computing devices, including hand-held computers, embedded computer systems, personal digital assistants, and other types of computing devices known to those skilled in the art. It is also contemplated that the computer architecture 400 may not include all of the components shown in FIG. 4, may include other components that are not explicitly shown in FIG. 4, or may utilize an architecture completely different than that shown in FIG. 4.

Based on the foregoing, it should be appreciated that technologies for providing recommendations based upon route query activity have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for providing recommendations, the computer-implemented method comprising performing computer-implemented operations for:
receiving a query associated with an entity;
capturing context information corresponding to the received query;
accessing route activity logs comprising data relating to requests for directions between at least two of origins, waypoints, follow-up points, and destinations; and
analyzing the received query, the context information, and the route activity logs to determine whether to generate the recommendations.

2. The method of claim 1, further comprising generating the recommendations, in response to the determining, wherein the recommendations comprise at least one of an additional recommended waypoint, an alternative destination, an alternative recommended waypoint, or a follow-up point.

3. The method of claim 1, further comprising generating an advertisement based upon at least one of the query, the context of the query, and the route activity logs, the route activity logs comprising data relating to route query activity during at last one session.

4. The method of claim 3, further comprising presenting the advertisement to the entity, the advertisement being presented to the entity during at least one of a first route query session during which the advertisement is generated or a second route query session occurring subsequent to the first route query session.

5. The method of claim 4, wherein the determining comprises determining whether to recommend a waypoint for inclusion in the route by:
analyzing the route activity logs and an area associated with the route to identify at least one place of interest;
determining a distance between the route and the place of interest; and
presenting the place of interest as a recommended waypoint for inclusion in the route with data indicating the distance between the route and the place of interest.

6. The method of claim 5, wherein presenting the place of interest comprises presenting an advertisement for the place of interest, and wherein the presented advertisement is determined based upon a probability that the entity is interested in the advertisement, the probability being determined based upon an analysis of the route activity logs and contents of the query.

7. The method of claim 1, further comprising generating an advertisement based upon at least one of the query, the context of the query, and the route activity logs, the route activity logs comprising data relating to route query activity during at last one session.

8. The method of claim 7, further comprising presenting data indicating how inclusion of the recommended waypoint will affect the route, the data comprising one or more of
an amount of time added to the route by adding the recommended waypoint,
a distance added to the route by adding the recommended waypoint,
an amount of time removed from the route by adding the recommended waypoint, or
a distance removed from the route by adding the recommended waypoint.

9. The method of claim 3, further comprising generating and displaying
a map comprising map information,
an advertisement comprising information relating to the recommended waypoint, and
the recommendation comprising the recommended waypoint.

10. The method of claim 8, further comprising:
defining a threshold beyond which recommended waypoints are not added, the threshold comprising at least one of a distance threshold or a time threshold,
determining if addition of the recommended waypoint to the route satisfies the defined threshold; and
presenting the recommended waypoint, in response to determining that the addition of the recommended waypoint satisfies the defined threshold.

11. The method of claim 10, wherein generating the route activity log comprises
capturing interactions of entities with a map application, the interactions comprising queries,
capturing context information associated with the queries, and
storing data relating to the interactions and the context information as the route activity logs.

12. A computer-implemented method for providing recommendations based upon a route query log, the computer-implemented method comprising performing computer-implemented operations for:
receiving a query associated with an entity, the query comprising a request for map information;
capturing context information corresponding to the received query;
accessing a route activity log associated with the entity, the route activity logs comprising data relating to requests for directions between at least two of origins, waypoints, follow-up points, and destinations; and
analyzing the received query, the context information, and the route activity logs to determine whether to generate recommendations relating to the query.

13. The method of claim 12, wherein the recommendations comprise at least one of an additional recommended waypoint, an alternative destination, an alternative recommended waypoint, or a follow-up point.

14. The method of claim 12, further comprising generating the recommendation, in response to the determining

15. The method of claim 12, wherein the determining comprises determining whether to recommend a waypoint for inclusion in the route by:
analyzing an area associated with the query to identify at least one place of interest;
determining a distance between the route and the place of interest;
presenting the place of interest as a recommended waypoint for inclusion in the route; and
presenting data indicating at least one of the distance between the route and the place of interest or a travel time between the route and the place of interest.

16. The method of claim 12, wherein the determining comprises determining whether to recommend a waypoint for inclusion in the route, and further comprising presenting data indicating how inclusion of the recommended waypoint will affect the route, the data comprising one or more of
an amount of time added to the route by adding the recommended waypoint,
a distance added to the route by adding the recommended waypoint,
an amount of time removed from the route by adding the recommended waypoint, or
a distance removed from the route by adding the recommended waypoint.

17. The method of claim 16, further comprising generating and displaying an advertisement relating to the recommendation.

18. The method of claim 16, further comprising defining a threshold beyond which recommended waypoints are not added, the threshold comprising at least one of a distance threshold or a time threshold,
determining if addition of the recommended waypoint to the route satisfies the defined threshold; and
in response to determining that the addition of the recommended waypoint satisfies the defined threshold,
presenting the recommended waypoint, and
generating new route information corresponding to the route including the recommended waypoint.

19. A computer-readable storage medium having computer-readable instructions stored thereupon that, when executed by a computer, cause the computer to:
receive a query associated with an entity, the query comprising a request for map information and directions between at least two of an origin, a destination, a waypoint, and a follow-up point;
capture context information corresponding to the received query;
access route activity logs, the route activity logs comprising data relating to requests for directions received by a map application;
analyze the received query, the context information, and the route activity logs to determine whether to generate recommendations relating to the query, the recommendations comprising at least one of an additional recommended waypoint, an alternative destination, an alternative recommended waypoint, or an additional follow-up point; and
generate the recommendations, in response to the determining.

20. The method of claim 19, wherein the determining comprises determining whether to recommend a waypoint for inclusion in the route by:
analyzing an area associated with the query to identify at least one place of interest;
determining a distance between the route and the place of interest;
presenting the place of interest as a recommended waypoint for inclusion in the route;
presenting data indicating at least one of the distance between the route and the place of interest or a travel time between the route and the place of interest; and
presenting an advertisement relating to the recommended waypoint.
